(19) United States
(12) Patent Application Publication
(10) Pub. No.: US 2025/0146587 A1
(43) Pub. Date: May 8, 2025

(54) VALVE ASSEMBLY FOR A THERMAL MANAGEMENT SYSTEM

(71) Applicant: Transportation IP Holdings, LLC, Norwalk, CT (US)

(72) Inventors: Alexander Shindledecker, Waterford, PA (US); Riley Nice, Grove City, PA (US); Charles Atz, Grove City, PA (US)

(73) Assignee: Transportation IP Holdings, LLC, Norwalk, CT (US)

(21) Appl. No.: 18/935,859

(22) Filed: Nov. 4, 2024

Related U.S. Application Data
(60) Provisional application No. 63/596,023, filed on Nov. 3, 2023.

(51) Int. Cl. F16K 17/38; F16K 31/60

(52) U.S. Cl. CPC F16K 17/38; F16K 31/60

(57) ABSTRACT

A valve assembly for a thermal management system of a vehicle may include an interface component having an elongated body that can removably couple with a connector of the thermal management system. For example, the interface component may be repeatedly coupled and decoupled from the connector without destroying or damaging the interface component or the connector. The interface component has an engagement body with a temperature-sensitive body that can automatically release the elongated body from the connector responsive to a temperature to which the temperature-sensitive body is exposed decreasing below a threshold temperature. The interface component has one or more drain holes that can direct a fluid that has entered the interface component to locations outside the valve assembly to prevent the fluid from freezing and prevent the elongated body from releasing from the connector of the thermal management system.

### CROSS-REFERENCE TO RELATED APPLICATION

This application claims benefit under 35 U.S.C. § 119 (e) to U.S. Provisional Application No. 63/596,023, filed Nov. 3, 2023, entitled “VALVE ASSEMBLY FOR A THERMAL MANAGEMENT SYSTEM,” the entire disclosure of which is hereby incorporated by reference herein.

### BACKGROUND

### Technical Field

The subject matter described herein relates to valves used to control the flow of working fluids in thermal management systems.

### Discussion of Art.

Thermal management systems can use working fluids to control the temperature of powered systems. For example, thermal management systems can flow coolants through conduits to keep temperatures of components in a vehicle to within acceptable ranges. One type of thermal management system for use in vehicles such as locomotives may use water to cool components (e.g., engines) of the vehicles. Water may be used as a coolant (or may be added to another coolant) in some vehicles due to the abundancy and cooling efficiency of water, the high heat capacity of water, and because water is both non-toxic and non-flammable.

One problem with using water in thermal management systems, however, is that water can freeze at temperatures in which the vehicles (e.g., locomotives) may travel. These thermal management systems can include dump valves that operate as a safety feature to release water in the thermal management systems before the water begins to freeze and build pressure in the thermal management systems to prevent damage or failure. These valves also can be referred to as relief valves. The valves release some coolant (which may be water or may include water) before the coolant freezes.

The dump valves can include wax or other bodies that change size, shape, or phase when the temperature decreases. For example, the wax bodies can become smaller to allow a stem inside the valve to be pushed downward by a spring. This movement of the stem opens holes inside a bearing holder in a handle of the valve. At least some of the water (or other coolant) can then exit the valve (and the conduits of the cooling system) to drain the water before freezing inside the thermal management system.

But water inside the dump valves can freeze and prevent the valves from opening. For example, water inside or around the stem in the valve can freeze and prevent the stem from being moved to open the holes in the bearing holder. As a result, the water may freeze and damage the thermal management system. It may be desirable to have a valve and method that differs from those that are currently available.

### BRIEF DESCRIPTION

In one embodiment, a valve assembly for a thermal management system of a vehicle may include an interface component having an elongated body that can removably couple with a connector of the thermal management system. For example, the interface component may be repeatedly coupled and decoupled from the connector without destroying or damaging the interface component or the connector. The interface component has an engagement body with a temperature-sensitive body that can automatically release the elongated body from the connector responsive to a temperature to which the temperature-sensitive body is exposed decreasing below a threshold temperature. The interface component has one or more drain holes that can direct a fluid that has entered the interface component to locations outside the valve assembly to prevent the fluid from freezing and prevent the elongated body from releasing from the connector of the thermal management system.

In one embodiment, a valve assembly can include an interface component having an elongated body and a handle that can be rotated to couple the elongated body to a thermal management system. The valve assembly can include an engagement body having a temperature-sensitive element and an actuator that is activated by the temperature-sensitive element responsive to a change in temperature in the thermal management system. The actuator can disengage the interface component from the thermal management system once actuated by the temperature-sensitive element to dispense a working fluid in the thermal management system out of the thermal management system via the handle. The handle can have drain holes extending through the handle and positioned to drain fluid out of the interface component that has entered the interface component from outside the valve assembly.

In one embodiment, a method may include comprising cutting or forming drain holes through a handle of a valve assembly configured to be coupled to a thermal management system. The drain holes can be cut or formed in the handle to drain fluid out of the valve assembly that has entered the valve assembly from outside the valve assembly and prevent freezing of the valve assembly to the thermal management system.

### BRIEF DESCRIPTION OF THE DRAWINGS

The subject matter may be understood from reading the following description of non-limiting embodiments, with reference to the attached drawings, wherein below:

FIG. 1 illustrates a perspective view of one example of a valve assembly;

FIG. 2 illustrates an exploded view of the valve assembly shown in FIG. 1;

FIG. 3 illustrates one example of a handle of the valve assembly shown in FIG. 1 with drain holes extending through a thickness of the handle; and

FIG. 4 illustrates another example of a handle of the valve assembly shown in FIGS. 1 through 3.

### DETAILED DESCRIPTION

Embodiments of the subject matter described herein relate to valve assemblies for thermal management systems. The valve assemblies may be used in vehicles or other powered systems. These systems may generate heat during operation. The valve assemblies can include actuators that open the valves responsive to a drop in temperature. This may allow coolant (e.g., water and/or another coolant) to exit the thermal management system. To reduce the chance of or prevent the actuators from freezing and being unable to open the valves, or open the valves fully, interface components of the valves can have drain holes that direct the coolant that has entered the valves to locations outside the valve assembly. This can reduce the chance of or prevent the valves from being frozen shut and unable to drain water before the water freezes.

Suitable vehicles may include locomotives, automobiles, trucks, buses, mining vehicles, agricultural vehicles, and the like. Suitable valve materials may include steel, nickel, and aluminum for some structural features, and elastomeric or polymeric materials for seals and gasket features. Suitable polymeric materials may include rubber and silicone. Other suitable polymeric materials may include polytetrafluoroethylene, nylon, Kraton and Viton. In one embodiment, a feature may be formed from wax or paraffin, as described in more detail below.

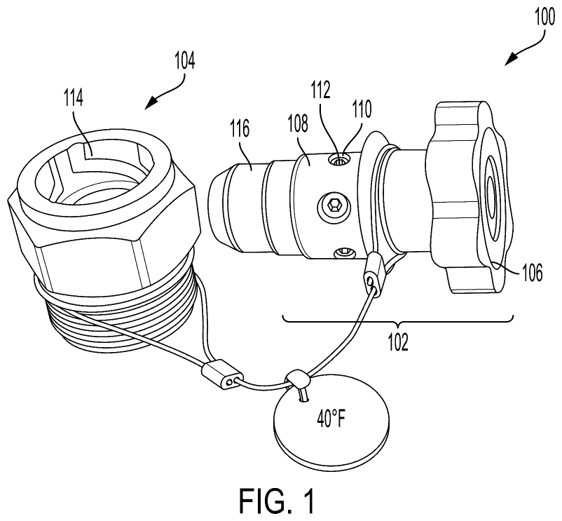

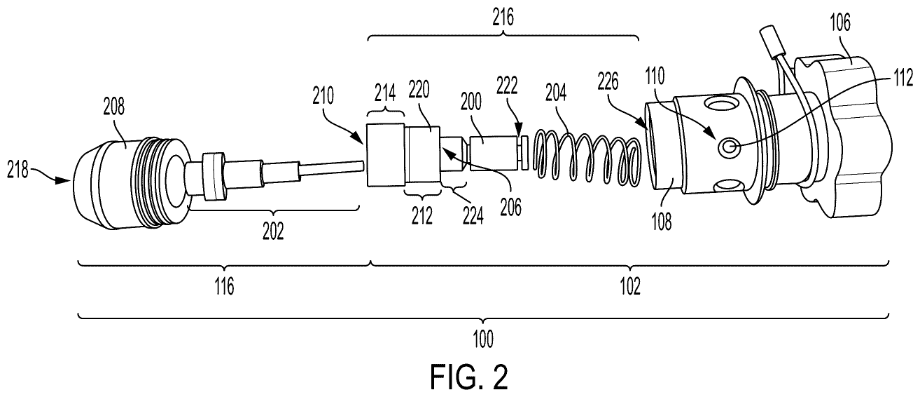

FIG. 1 illustrates a perspective view of one example of a valve assembly 100. The valve assembly may be used in a thermal management system, such as a cooling system for a powered system (e.g., a vehicle). FIG. 2 illustrates an exploded view of the valve assembly shown in FIG. 1. The valve assembly optionally can be referred to as a dump valve that can open to permit fluid to drain or dump out of the thermal management system responsive to a change (e.g., drop) in temperature. The valve assembly includes an interface component 102 that can couple the valve assembly with a connector 104 of a thermal management system. The interface component optionally can be referred to as a valve head. The interface component can include a handle 106 that can be actuated (e.g., rotated) to fluidly connect the valve assembly with the thermal management system via the connector. The connector may connect with conduits in the thermal management system that directs working fluid (e.g., water and/or a coolant) through and/or around components in a powered system (e.g., a vehicle) to control the temperature of the components (e.g., cool the components). For example, the valve assembly may be inserted into the connector and the handle rotated to connect the valve assembly with the thermal management system. Once the valve assembly is coupled with the connector, the valve assembly can prevent fluid in the thermal management system from exiting the thermal management assembly via the connector unless or until temperature drops below a lower temperature threshold.

The interface component can include an elongated body 108 with an inner surface 226 that defines or includes at least one opening 110. This inner surface may define the interior or an interior cavity of the elongated body. The inner surface may be formed from the same material as the remainder or the bulk of the elongated body. Optionally, the inner surface may include or have a coating, such as a hydrophobic coating. One or more retractable projections 112 may extend from these openings. These projections may include ball bearings or other bodies that can radially project outward from the openings. The connector of the thermal management system may include internal threads 114 that can receive the retractable projections to secure the valve assembly to the connector. The interface component may include an actuation assembly 216 that is at least partially disposed in the interface component. As described below, the actuation assembly can operate to retract the retractable projections in the interface component to allow the interface component to automatically disengage from the connector of the thermal management system responsive to a temperature (e.g., of the coolant or water) dropping below a threshold temperature. Without the use of the subject invention, this operation may be impeded or prevented while the retractable projections are frozen in place and unable to retract from the threads in the connector of the thermal management system.

A valve body 116 may be partially disposed in the actuation assembly, which is then at least partially disposed within the elongated body of the interface component. The valve body and the actuation assembly optionally can be referred to as a cartridge body (that includes both the valve body and the actuation assembly). The valve body includes an inlet body 208 having an opening 218 at the bottom side of the valve body. Water or coolant in the thermal management system can enter the valve assembly via this opening in the inlet body. The inlet body may be a conduit or have an annular shape with an inner conduit 202 extending into the inlet body. The inner conduit may be a tube or other body through which the coolant or water in the thermal management system can flow (e.g., from the inlet opening in the inlet body).

The inner conduit of the valve body can be received or can extend into an engagement body 220 of the actuation assembly. This engagement body may be a tubular body or conduit that receives the inner conduit. The engagement body includes or is connected with an actuating stem or conduit 200 of the actuation assembly. The inner conduit of the valve body can extend into and through the interior of the engagement body 220 and extend into the actuating stem or conduit.

As shown, the actuating stem includes an exhaust or outlet opening 222 at an end of the actuating stem that is opposite the end into which the inner conduit is received. Coolant or water in the thermal management system can flow into the inlet opening 218 in the inlet body, flow through the inlet body, flow into the inner conduit, flow out of the inner conduit into the engagement body, and flow out of the engagement body through the outlet opening. The actuating stem may be at least partially disposed within and partially extend through the interface body so that the outlet opening of the actuation assembly can project through the handle of the interface component. This can allow for the coolant or water in the thermal management system to flow through the valve assembly and out of the valve assembly via the outlet opening projecting through the handle of the interface component.

The outer or external surface of the engagement body may be staged in diameter with a largest diameter section 214, a middle diameter section 212, and a smallest diameter section 224. Optionally, the engagement body may have fewer or more sections of the same or different diameters. The inner conduit of the valve body can be received into the largest diameter section of the engagement body. The inner conduit can extend through the inside of the engagement body (which may be an annular body or conduit itself) through the largest, middle, and smallest diameter sections, and may extend into the actuating step of the engagement body. The interface between two or more of the diameter sections of the engagement body have form a step or shoulder 206.

An actuator 204 of the actuation assembly can include a resilient body or compressive body. Suitable resilient bodies may be a spring or elastomer. This actuator can be compressed between the stop or shoulder of the engagement body and an interior surface or step inside the elongated body 108 of the interface component. In a biased state or condition, the actuator is biased (e.g., compressed) between the step of the engagement body and the step inside the interface component. In an actuated state or condition, the actuator is not biased (e.g., is not compressed) and pushes the engagement body away from the interface component.

A temperature-activated body 210 can be disposed in the engagement body. This temperature-activated body may be in contact with the inner conduit inside the engagement body between the engagement body and the inner conduit. This temperature-activated body can change size, shape, and/or phase based on or responsive to a change in the temperature. For example, the temperature-activated body may be a wax body that shrinks when the temperature decreases and returns to its original size when the temperature rises (e.g., the size of the body prior to the temperature decreasing).

In operation, while the ambient temperature (to which the temperature-activated body inside the valve assembly is exposed) is at or above a threshold temperature, the wax body does not shrink and thereby maintains a designated separation distance between the engagement body and the inner conduit. This can keep the activator (e.g., the spring) in the biased or compressed state between the shoulder of the engagement body and the inside of the interface component. The threshold temperature may be at or above the temperature at which water and/or other coolants freeze. Freezing may occur at a temperature of zero degrees Celsius for pure water. The eutectic point for the coolant may be controlled with various additives. Suitable additives may include salts, glycols, alcohols, and the like. Selection of a threshold temperature for the body's response may be made with reference to the coolant eutectic point. In one embodiment, wax selection includes choosing a length of the carbon chain (with lower chain lengths having a higher melt temperature than higher chain lengths). Further, blends of wax molecules of differing chain lengths may be selected to achieve a desired melt profile for the wax. Further, in some embodiments, a filler material dispersed within the wax may affect its expansion and contraction response to temperature. Glass or polymeric hollow spheres may be used, for example, to obtain a desired thermal coefficient of expansion (CTE).

While the ambient temperature is at or above the threshold temperature, the temperature-activated body keeps the actuator in the biased state. The retractable projections may rest (in the projection openings) on the largest diameter portion of the engagement body. While in this position or state, the retractable projections may extend out of the projection openings and be in contact with the internal threads of the connector of the thermal management system. This can prevent or reduce the chance of the interface component moving or exiting the connector.

After the ambient temperature drops below the threshold temperature, the temperature-activated body may shrink in size, thereby allowing the actuator to extend in length and push the engagement body toward the valve body and away from the interface component. This also moves the largest diameter portion of the engagement body away from the interface components and retractable projections. This can cause the middle diameter portion or the smallest diameter portion to be in contact or be behind the retractable projections. This can allow the retractable projections to retract into the projection openings in the interface component and out of the internal threads of the connector. The connector may be oriented downward toward the ground with the handle of the valve assembly facing the ground. The valve assembly can then automatically disconnect from the connector and allow fluid in the thermal management system to exit from the thermal management system via the connector.

Water may enter the interface component due to condensation, wheels of a vehicle kicking up water into the valve assembly, operators dipping the valve assembly in hot water or coffee to melt existing ice which then later freezes, driving rain, and the like. If water enters the interface component and freezes, the retractable projections may be frozen in place and unable to retract and allow the interface component to automatically decouple from the threads in the connector. This can prevent the valve assembly from operating and draining water in the thermal management system from freezing and causing damage to or failure of the thermal management system.

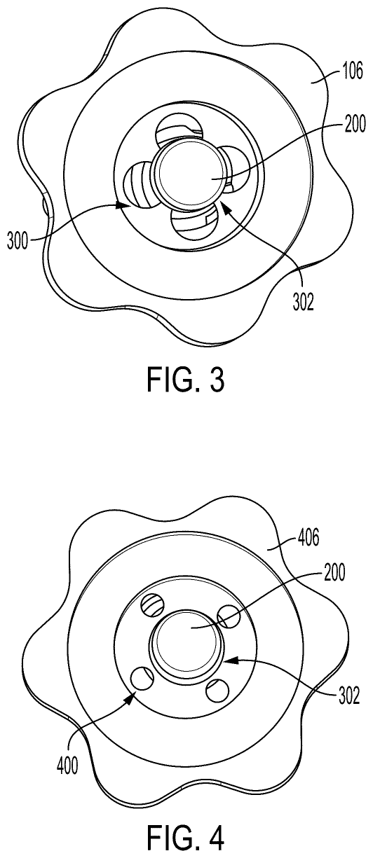

To prevent or reduce the chance of this occurring, the handle of the valve assembly may have an inner surface that defines one or more drain holes. These drain holes may allow fluid in the interface component to drain out of the interface component. That draining may be done prior to freezing. FIG. 3 illustrates one example of the handle of the valve assembly with drain holes 300 extending through the thickness of the handle. The handle includes a central opening 302 through which the stem may protrude when activated by (e.g., pushed) the actuator. As shown in FIG. 3, the stem can extend or project through the central opening. Some known valve assemblies do not have the drain holes extending through the handle. As a result, water that gets into the handle (e.g., via interfaces between components) can freeze the interface component to the connector, thereby preventing or reducing the chance that the valve assembly will automatically operating to open and release the fluid in the thermal management system before the fluid freezes inside the thermal management system. The drain holes in the inventive valve assemblies described herein can allow for this water or other fluids to drain out of the interface component and thereby not freeze the valve assembly. For example, the water may drain out of the drain holes and not freeze the retractable projections, not freeze the interface component to the connector, or the like. This can allow the valve assembly to continue to operate automatically open and allow the fluid(s) in the thermal management system to drain out of the connector if the temperature in the thermal management system drops below the threshold temperature. In one embodiment, at least a portion of the inner surface of the interface component may be coated with a hydrophobic coating. In other embodiments, there may be no coating or the coating may differ in function, such as being a wicking material.

As described above, the valve assembly may be oriented on the thermal management system or the vehicle with the handle oriented downward or angled toward the ground beneath the vehicle and the thermal management system. As a result, one or more of the drain holes may be oriented downward. This allows gravity to drain the water inside the valve assembly out of the drain holes. There may be a single drain hole in the handle, or there may be two or more drain holes. In the illustrated example, there are two pairs or sets of drain holes in the handle, with each pair or set including opposing drain holes on opposite sides of the center of the handle (or on opposite sides of the stem). This can ensure that at least one drain hole is positioned to drain water out of the valve assembly regardless of how far the handle is rotated when coupling the valve assembly to the connector.

FIG. 4 illustrates another example of a handle 406 of the valve assembly shown in FIGS. 1 through 3. The handle shown in FIG. 4 may be used in place of the handle shown in FIGS. 1 through 3. The handle shown in FIG. 4 differs in that drain holes 400 in the handle of FIG. 4 do not intersect the central opening 302 of the handle. For example, the drain holes in FIG. 3 are not enclosed circular openings but intersect with the central opening so that the central opening and the drain holes form one continuous opening through the handle. In contrast, the drain holes shown in FIG. 4 are separate from each other and from the central opening. Each drain hole in FIG. 4 is surrounded by portions of the handle such that no drain hole intersects any other drain hole or the central opening in the handle. This can help maintain structural integrity and rigidity of the handle as there is more material of the handle between the openings compared to the handle shown in FIG. 3. Similar to the handle shown in FIG. 3, the handle shown in FIG. 4 includes opposing or opposite pairs of the drain holes.

A method for forming one or more of the valve assemblies described herein may include cutting or forming drain holes through a handle of a valve head in a valve assembly. The drain holes may be cut using one or more cutting tools to retrofit an existing valve assembly. Optionally, the drain holes may be formed when the handle is created.

A valve assembly for a thermal management system of a vehicle may include an interface component having an elongated body configured to removably couple with a connector of the thermal management system. The interface component has an engagement body with a temperature-sensitive body that can automatically release the elongated body from the connector responsive to a temperature to which the temperature-sensitive body is exposed decreasing below a threshold temperature. The interface component can have an inner surface that defines one or more drain holes. The interface component can direct a fluid that has entered the interface component to locations outside the valve assembly.

The interface component can include a handle that can be manually actuated to couple the interface component with the connector of the thermal management system. The handle can have the inner surface that defines the one or more drain holes. The interface component can have retractable projections that automatically retract responsive to the temperature that the temperature-sensitive body is exposed being colder than the threshold temperature. The actuator can de-couple the retractable projections from internal threads of the connector of the thermal management system.

The inner surface can be shaped so that the one or more drain holes include at least two drain holes that are an opposing pair of drain holes. The interface component can drain fluid from inside the interface component through the drain holes and out of the interface component to thereby prevent or reduce a chance of residual fluid remaining inside the interface component such that the residual fluid could freeze and block the elongated body from releasing from the connector of the thermal management system.

At least a portion of the inner surface of the interface component can be coated with a hydrophobic coating. The interface component can couple with the thermal management system with the one or more drain holes oriented downward.

Another valve assembly can include an interface component having an elongated body and a handle that can be rotated to couple the elongated body to a thermal management system. The valve assembly can include an engagement body having a temperature-sensitive element and an actuator that is activatable by the temperature-sensitive element responsive to a change in temperature in the thermal management system. The actuator can disengage the interface component from the thermal management system once actuated by the temperature-sensitive element to dispense a working fluid in the thermal management system out of the thermal management system via the handle. The handle can have an inner surface that defines one or more drain holes extending through the handle and that are positioned to allow fluid to drain out of the interface component after such fluid has entered the interface component.

The inner surface can define at least a pair of drain holes that oppose each other across a center of the handle. At least a portion of the inner surface of the interface component can be coated with a hydrophobic coating. The interface component can include retractable protrusions positioned to engage threads in the thermal management system.

The actuator can include a compressive body that, responsive to the temperature-sensitive element actuating the actuator, expands to move the engagement body relative to retractable projections in the interface component and thereby retract the retractable protrusions and release the interface component from the thermal management system. The drain holes in the handle can be oriented downward while the interface component is coupled with the thermal management system.

The temperature-sensitive body can be a wax body. The temperature-sensitive body can respond to a change in temperature by one or more of changing size, shape, or phase. The engagement body can be a dump valve.

The actuator can include a spring and the temperature-sensitive body can shrink in size to allow the spring to push a stem inside the engagement body in a direction away from the interface component.

In another example, a dump valve includes a body in which a spring and a stem are located. The body can include an inner surface that defines openings through which retractable projections protrude to engage internal threads of a connector of a thermal management system and retract to release from the internal threads of the connector. The dump valve also can include a wax body that can change one or more of size, shape, or phase responsive to a drop in temperature to release the spring to move the stem within the body to dump a fluid in the thermal management system out via the body. The dump valve also may include a handle that can be coupled with the body and can be rotated to engage the retractable projections with the internal threads of the connector. The handle can include drain openings that permit water trapped in the body to drain out of the body and avoid freezing the retractable projections in place.

The handle can include the drain openings in different locations so that at least one of the drain openings is oriented downward to allow gravity to drain the water trapped in the body out of the body.

A method may include cutting or forming drain holes through a handle of a valve assembly configured to be coupled to a thermal management system. The drain holes can be cut or formed in the handle to drain fluid out of the valve assembly that has entered the valve assembly from outside the valve assembly and prevent or reduce the chance of freezing of the valve assembly to the thermal management system. The drain holes can be cut, punched, drilled or formed around a center of the handle depending on the end use requirements and manufacturing method.

Use of phrases such as “one or more of . . . and,” “one or more of . . . or,” “at least one of . . . and,” and “at least one of . . . or” are meant to encompass including only a single one of the items used in connection with the phrase, at least one of each one of the items used in connection with the phrase, or multiple ones of any or each of the items used in connection with the phrase. For example, “one or more of A, B, and C,” “one or more of A, B, or C,” “at least one of A, B, and C,” and “at least one of A, B, or C” each can mean (1) at least one A, (2) at least one B, (3) at least one C, (4) at least one A and at least one B, (5) at least one A, at least one B, and at least one C, (6) at least one B and at least one C, or (7) at least one A and at least one C.

As used herein, an element or step recited in the singular and preceded with the word “a” or “an” do not exclude the plural of said elements or operations, unless such exclusion is explicitly stated. Furthermore, references to “one embodiment” of the invention do not exclude the existence of additional embodiments that incorporate the recited features. Moreover, unless explicitly stated to the contrary, embodiments “comprising,” “comprises,” “including,” “includes,” “having,” or “has” an element or a plurality of elements having a particular property may include additional such elements not having that property. In the appended claims, the terms “including” and “in which” are used as the plain-English equivalents of the respective terms “comprising” and “wherein.” Moreover, in the following claims, the terms “first,” “second,” and “third,” etc. are used merely as labels, and do not impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function devoid of further structure.

This written description uses examples to disclose several embodiments of the subject matter, including the best mode, and to enable one of ordinary skill in the art to practice the embodiments of subject matter, including making and using any devices or systems and performing any incorporated methods. The patentable scope of the subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

1. A valve assembly for a thermal management system of a vehicle, the valve assembly comprising:
an interface component having an elongated body configured removably couple with a connector of the thermal management system, the interface component having an engagement body with a temperature-sensitive body that is configured to automatically release the elongated body from the connector responsive to a temperature to which the temperature-sensitive body is exposed decreasing below a threshold temperature,
the interface component having an inner surface that defines one or more drain holes, and is configured to direct a fluid that has entered the interface component to locations outside the valve assembly.

2. The valve assembly of claim 1, wherein the interface component includes a handle that is configured to be manually actuated to couple the interface component with the connector of the thermal management system, the handle having the inner surface that defines the one or more drain holes.

3. The valve assembly of claim 1, wherein the interface component has retractable projections that automatically retract responsive to the temperature that the temperature-sensitive body is exposed being colder than the threshold temperature.

4. The valve assembly of claim 3, wherein the actuator is configured to de-couple the retractable projections from internal threads of the connector of the thermal management system.

5. The valve assembly of claim 1, wherein the inner surface is configured such that the one or more drain holes include at least two drain holes that are an opposing pair of drain holes.

6. The valve assembly of claim 1, wherein the interface component is configured to drain fluid from inside the interface component through the drain holes and out of the interface component, and thereby to prevent or reduce a chance of residual fluid remaining inside the interface component such that the residual fluid could freeze and block the elongated body from releasing from the connector of the thermal management system.

7. The valve assembly of claim 1, wherein at least a portion of the inner surface of the interface component is coated with a hydrophobic coating.

8. The valve assembly of claim 1, wherein the interface component is configured to couple with the thermal management system with the one or more drain holes oriented downward.

9. A valve assembly, comprising:
an interface component having an elongated body and a handle configured to be rotated to couple the elongated body to a thermal management system; and
an engagement body having a temperature-sensitive element and an actuator that is activatable by the temperature-sensitive element responsive to a change in temperature in the thermal management system, the actuator being configured to disengage the interface component from the thermal management system once actuated by the temperature-sensitive element to dispense a working fluid in the thermal management system out of the thermal management system via the handle,
the handle having an inner surface that defines one or more drain holes extending through the handle and positioned to allow fluid to drain out of the interface component after such fluid has entered the interface component.

10. The valve assembly of claim 9, wherein the inner surface defines at least a pair of drain holes that oppose each other across a center of the handle.

11. The valve assembly of claim 9, wherein at least a portion of the inner surface of the interface component is coated with a hydrophobic coating.

12. The valve assembly of claim 9, wherein the interface component includes retractable protrusions positioned to engage threads in the thermal management system.

13. The valve assembly of claim 12, wherein the actuator includes a compressive body that, responsive to the temperature-sensitive element actuating the actuator, expands to move the engagement body relative to retractable projections in the interface component and thereby retract the retractable protrusions and release the interface component from the thermal management system.

14. The valve assembly of claim 9, wherein the drain holes in the handle are configured to be oriented downward while the interface component is coupled with the thermal management system.

15. The valve assembly of claim 9, wherein the temperature-sensitive body is a wax body.

16. The valve assembly of claim 9, wherein the temperature-sensitive body is configured to respond to a change in temperature by one or more of changing size, shape, or phase.

17. The valve assembly of claim 9, wherein the engagement body is a dump valve.

18. The valve assembly of claim 9, wherein the actuator includes a spring and the temperature-sensitive body is configured to shrink in size to allow the spring to push a stem inside the engagement body in a direction away from the interface component.

19. A dump valve, comprising:
a body in which a spring and a stem are located, the body including an inner surface that defines openings through which retractable projections protrude to engage internal threads of a connector of a thermal management system and retract to release from the internal threads of the connector;
a wax body configured to change one or more of size, shape, or phase responsive to a drop in temperature to release the spring to move the stem within the body to dump a fluid in the thermal management system out via the body; and
a handle coupled with the body and configured to be rotated to engage the retractable projections with the internal threads of the connector, the handle including drain openings that permit water trapped in the body to drain out of the body and avoid freezing the retractable projections in place.

20. The dump valve of claim 19, wherein the handle includes the drain openings in different locations so that at least one of the drain openings is oriented downward to allow gravity to drain the water trapped in the body out of the body.
